(19) United States
(12) Patent Application Publication
(10) Pub. No.: US 2005/0134272 A1
(43) Pub. Date: Jun. 23, 2005

(54) Device for enabling reduced motion-related artifacts in parallel magnetic resonance imaging

(76) Inventors: Timothy Paul Leslie Roberts, Toronto (CA); Marshall Stephen Sussman, Toronto (CA); Elissa Jill Flagg, Toronto (CA)

Correspondence Address: Ralph A. Dowell of DOWELL & DOWELL P.C., 2111 Eisenhower Ave., Suite 406, Alexandria, VA, 22314, US

(21) Appl. No.: 10/995,219

(22) Filed: Nov. 24, 2004

Related U.S. Application Data
(60) Provisional application No. 60/525,832, filed on Dec. 1, 2003.

(51) Int. Cl. G01V 3/00

(52) U.S. Cl. 324/318; 324/309

(57) ABSTRACT

The present invention provides several embodiments of a device for physically separating RF imaging coils from any source of movement thereby minimizing potential coil-displacement related reconstruction effect or artifact. The device can be used to enable parallel imaging of the abdomen, pelvis and other moving body parts such that normal or abnormal patient movement does not displace the coil elements between the calibration scan and the subsequent imaging scans.

### CROSS REFERENCE TO RELATED U.S APPLICATION

This patent application relates to, and claims the priority benefit from, U.S. Provisional Patent Application Ser. No. 60/525,832 filed on Dec. 1, 2003, which is incorporated herein by reference in its entirety.

### FIELD OF THE INVENTION

The present invention relates to a method and device used in medical imaging. In particular, the invention is related to a method and device for enabling reduced motion-related displacement artifacts in parallel magnetic resonance imaging.

### BACKGROUND OF THE INVENTION

Magnetic Resonance Imaging (MRI) is based on the absorption and emission of energy in the radio frequency range. A patient is placed in a magnetic resonance scanner that provides a uniform magnetic field that causes the alignment of the moments of the magnetic spin of atoms contained within the patient. The magnetic resonance scanner further provides multiple coils that apply a transverse magnetic field, generated by RF pulses, to the patient such that the aligned moments rotate or tip thereby exciting the spins of the atoms. The excited spins of the atoms generate a signal that is detected by imaging coils contained within the magnetic resonance scanner. The data obtained by the imaging coils is collectively referred to as k-space data which comprises multiple lines or rows of data called phase encodes or echoes. A set of k-space data is acquired for each image frame and converted to an image by applying a Fast Fourier Transform.

One of the major recent advances in MRI has been the development of “parallel imaging with sensitivity encoding” using multiple radio frequency (RF) coil elements to reduce echo train lengths in multi-echo (e.g. fast spin echo and echo planar imaging) and echo numbers in single echo (e.g. spin echo and gradient recalled echo) MRI scans, with associated improvement in image sharpness and acquisition speed. This methodology has been commercialized by at least three major MRI vendors (Philips, GE, Siemens) and marketed as “SENSE”, “ASSET” or “iPAT” products.

In the parallel imaging methodology, only part of the k-space data (i.e. under-sampling) is used to generate the MRI images with the effect of reducing the field of view, leading to foldover or aliasing. Using multiple receiver coils each with different (and known) spatial sensitivities allows unfolding of the overlapping data and reconstruction of the full field of view image. However, when the under-sampled k-space data is converted to an MRI image, the resulting images have aliasing defects called artifacts or ghost artifacts. Several image processing techniques have been developed to reduce the affects of ghost artifacts such as the SENSE and SMASH methods in which complex data from the multiple imaging coils are obtained in parallel and weighted in such a way to suppress under-sampling artifacts in the final reconstructed image. The weighting provides spatial filtering which is done in the k-space domain (as in the SMASH method) or in the image domain (as in the SENSE method).

The complex weights that are used in the SMASH and SENSE methods are related to the coil sensitivities of the imaging coils. The coil sensitivity depends on the proximity of the imaging coils to the patient. Furthermore, it is common practice to place the imaging coils as close to the patient as possible to increase the Signal-to-Noise ratio of the acquired data. Accurate knowledge of coil sensitivities is crucial for parallel MRI, and errors in calibration represent one of the most common and the most pernicious sources of error in parallel image reconstructions. Accordingly, these techniques rely on the “calibration” or “sensitivity encoding” of the multi-coil imaging array (typically achieved by means of a low-resolution scan of the object with individual coil images stored separately). Subsequent multicoil or “parallel” imaging requires this calibration scan data during the reconstruction process to deliver the final image, without foldover or aliasing artifact. Calibration is done before, and/or during, and/or after obtaining imaging data and it is assumed that the sensitivities of the coils remain static during data acquisition or between calibration data and image data acquisition. However, in practice if the coil moves during data acquisition, for example due to breathing, the estimated coil sensitivities will be compromised, ghost artifacts will be generated and the resulting image quality will degrade.

An attractive opportunity for parallel imaging exists in the abdomen and pelvis, where scans are typically limited in quality by the requirement for acquisition to be completed during a single period of suspended respiration (breath-hold). Since parallel imaging increases acquisition speed and/or decreases echo train length, improved image quality can be obtained within the same (typically 20-30 sec) period of scanning. However, most multi-element RF coils for imaging of the abdomen are of a flexible design, typically tightly coupled to the patient abdomen (to achieve maximum signal to noise ratio). As such the RF imaging coils are physically displaced by normal and abnormal patient motion (such as respiration). Accordingly, the problem of varying coil sensitivity is particularly pronounced for imaging of the abdomen, where calibration scans and images are typically acquired during separate periods of suspended respiration (breath-holds) which are rarely precisely reproducible. In fact, the problem is so severe that the ghost artifact mechanism may impose a limitation on the use of these accelerated imaging methods in some settings.

Approaches to achieve more uniform breath-holds have been proposed to address this issue such as providing feedback of abdomen wall position to the patient. However, these approaches are limited by patient compliance and reproducibility. Further, respiration is only one source of coil displacement. Other applications of MR imaging such as “interventional” or study of joint kinematics involve other types of motion and hence cannot use an approach related to minimizing coil movement due to respiration.

### SUMMARY OF THE INVENTION

In accordance with a first aspect, the present invention provides several embodiments of a device for physically separating RF imaging coils from any source of movement, thereby eliminating any potential coil-displacement related reconstruction effect or artifact. The device can be used to enable parallel imaging of the abdomen, pelvis and other moving body parts such that normal or abnormal patient movement does not displace the coil elements between the calibration scan and the imaging scans.

In one aspect of the invention there is provided a method of parallel magnetic resonance imaging, comprising the steps of placing a patient on a magnetic resonance imaging (MRI) table and positioning anterior coil elements of a RF multi-coil imaging array around the patient at a sufficient distance so that the patient does not contact or otherwise move the coils, then performing a calibration scan of the multi-coil imaging array and storing calibration scan data; performing a scan with the multi-coil imaging array and obtaining imaging data of a selected part of a patient's body and storing the imaging data. The calibration scan data and the imaging data is processed to produce a final MRI image of the selected part of a patient's body.

In another aspect of the invention there is provided a device for retrofitting to a magnetic resonance imaging apparatus for physically separating RF imaging coils from any source of movement by a patient thereby eliminating any potential coil-displacement related reconstruction effect or artifact in parallel magnetic resonance imaging, comprising:
rigid support members being attached to a magnetic resonance imaging apparatus, an RF multi-coil imaging array being attached to the rigid support members with the rigid support members being positioned with respect to a patient lying on a magnetic resonance imaging (MRI) table so that the RF multi-coil imaging array is positioned at a sufficient distance from the patient so that the patient does not contact or otherwise move the coils during movement, voluntary or involuntary.

### BRIEF DESCRIPTION OF THE DRAWINGS

For a better understanding of the present invention and to show more clearly how it may be carried into effect, reference will now be made, by way of example, to the accompanying drawings which show a preferred embodiment of the present invention and in which:

FIG. 1 is a block diagram of an embodiment of a coil immobilization device in accordance with the present invention;

FIG. 2 is a block diagram of an alternative embodiment of a coil immobilization device in accordance with the present invention;

FIG. 3 is a block diagram of another alternative embodiment of a coil immobilization device in accordance with the present invention;

FIG. 4 is a block diagram of another alternative embodiment of a coil immobilization device in accordance with the present invention;

FIG. 4b is a perspective view of another alternative embodiment of a coil immobilization device accordance with the present invention;

FIG. 4c is a perspective view of an MRI apparatus which has been retrofitted with the coil immobilization device shown in FIG. 4b;

FIG. 5 is a diagram illustrating a water phantom due to the effects of object displacement with and without a coil immobilization device;

FIG. 6 is another diagram illustrating a water phantom due to the effects of object displacement with and without a coil immobilization device;

FIG. 7 is a diagram illustrating MRI images obtained with and without a coil immobilization device; and

FIG. 8 is a diagram of an alternative embodiment of a coil immobilization device in accordance with the present invention in which Illustrations are shown for coils arranged in an “anterior/posterior” configuration, analogous coil arrays with coil elements to the “left” and “right” of the object are similarly considered.

### DETAILED DESCRIPTION OF THE INVENTION

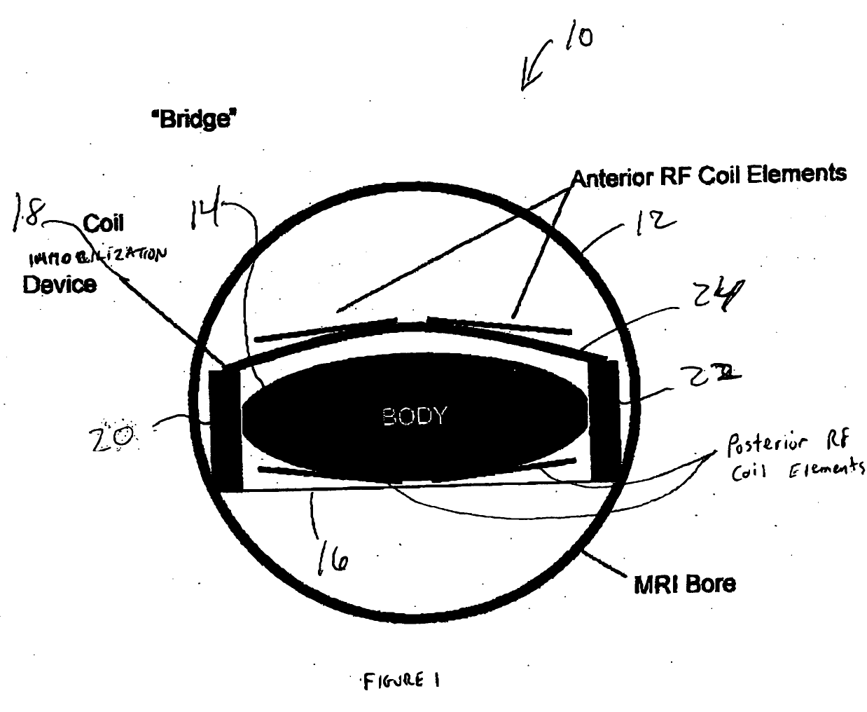

Referring now to FIG. 1, shown therein is a block diagram of an embodiment of a coil immobilization device in accordance with the present invention. FIG. 1 is a cross-sectional view of the body of a patient in the MRI bore of an MRI scanner. The MRI scanner includes excitation RF coils (not shown) for generating excitation magnetic fields that create changes in the magnetic spin moments of the atoms in the patient's body. The changes in the magnetic spin moments provides data that is recorded by the anterior and posterior imaging RF coil elements.

The anterior RF coil elements are statically held in place by the coil immobilization device. The posterior RF coil elements are integrated into a cushion (not shown) or the platform upon which the patient lies. The posterior RF coils cannot move regardless of whether the patient moves.

In current practice by those skilled in the art, the anterior RF coils are placed directly on the outer wall of the patient's body for imaging for improving the Signal-to-Noise ratio of the resulting MRI images. It was previously thought that such “FLEX” coils are best. However, in the case of parallel imaging, the use of FLEX coils, in part, generates ghost artifacts in the resulting MRI images when body parts that move, for whatever reason, are imaged.

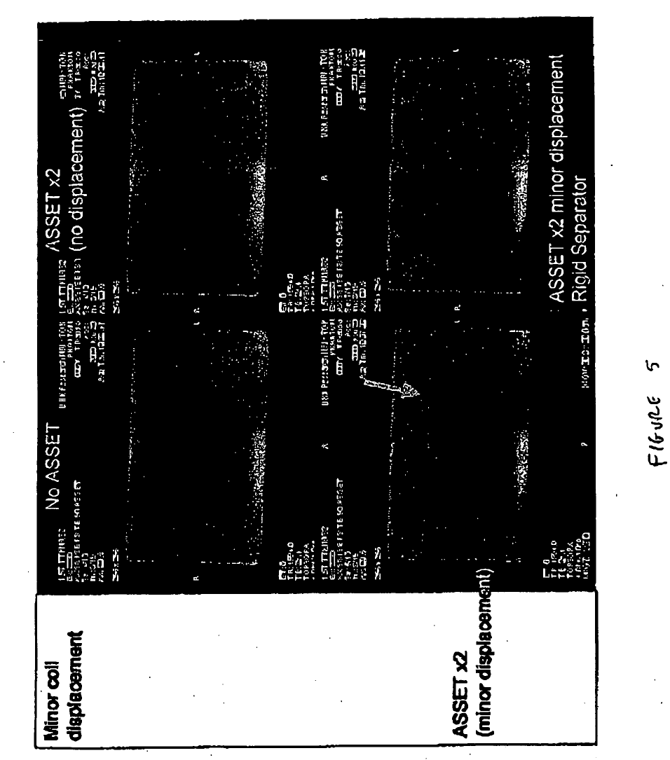

The inventors have therefore devised the coil immobilization device which is used to separate the anterior and posterior RF imaging coil elements, such that normal or abnormal physiologic movement of the patient's (or healthy subject's) abdomen (or other body part) does not displace the imaging coil elements. As such, the necessary “parallel imaging sensitivity calibration scan” and the desired “parallel image with sensitivity encoding” can be acquired with the imaging coils in identical physical positions. Consequently, displacement-related reconstruction artifacts (see FIGS. 5-7), which typically manifest as shifted, interfering “ghost” images, will be minimized.

In the embodiment shown in FIG. 1, an MRI system shown generally at 10 includes an MRI bore 12 into which a patient 14 is positioned on an MRI table 16 and an anterior RF coil array and a posterior RF imaging coil array. A coil immobilization device 18 comprises two distancing members 20 and 22 and a support member 24 upon which the anterior RF imaging coil array rests. The height of the distancing members 20 and 22 can be adjusted to accommodate patients 14 with different body cavity thickness. Alternatively, there may be several distancing members with various heights that can be attached to the support member. Further, the support member 24 may be arched as shown in FIG. 1 or can be straight. The coil immobilization device can be placed over the patient 14 before the patient is slid into the MRI bore.

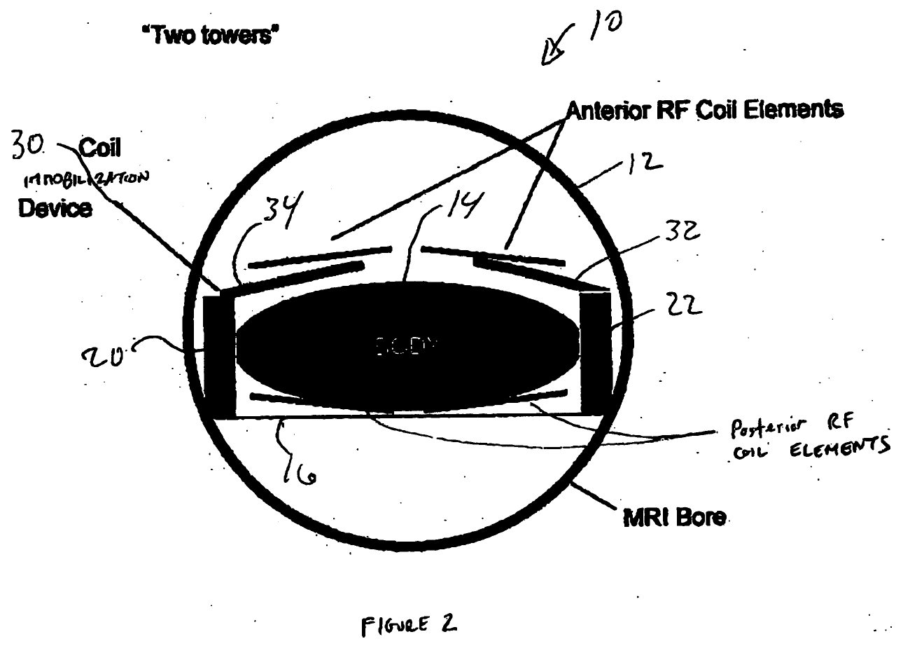

Referring now to FIG. 2, shown therein is a block diagram of an alternative embodiment of a coil immobilization device 30 in accordance with the present invention. The coil immobilization device 30 comprises two distancing members 20 and 22 and two support members 32 and 34 upon which the anterior RF imaging coil array rests. The height of the distancing members 20 and 22 can be adjusted to accommodate patients 14 with different body cavity thickness. Alternatively, there may be several distancing members with various heights that can be attached to the support members, Further, the support members 32 and 34 can be angled upwards as shown in FIG. 2 or they can project horizontally from the standing members 20 and 22. The coil immobilization device 30 can be placed over the patient 14 before the patient is slid into the MRI bore 12.

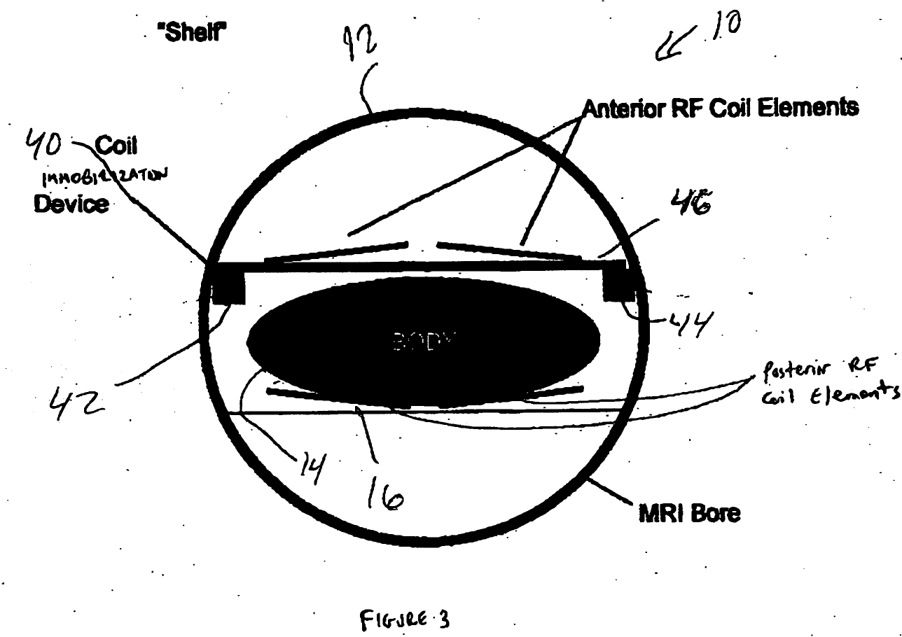

Referring now to FIG. 3, shown therein is a block diagram of another alternative embodiment of a coil immobilization device 40 in accordance with the present invention. The coil immobilization device 40 comprises two bracket members 42 and 44 and a support member 46 upon which the anterior RF imaging coil array rests. The bracket members 42 and 44 are mounted on the inside surface of the MRI bore 12. Only two bracket members are shown for simplicity. However, there are actually several bracket members on each inner portion of the MRI bore. Using one of the inner sides of the MRI bore as an example, the bracket members 42 and 44 are aligned vertically with respect to one another so that the support member can be mounted at several heights to accommodate patients 14 with different body cavity thickness. Accordingly, the bracket members 42 and 44 on either inner side of the MRI bore 12 that correspond to a particular height are horizontally aligned with respect to one another. Further, the support member 46 can be horizontal as shown in FIG. 2 or can have straight edges which slide within, or on top of, the bracket members 42 and 44 and an arched middle portion (not shown). The support member 46 of the coil immobilization device is slid or placed on (depending on the design of the brackets) a particular pair of brackets at a suitable height before the patient is slid into the MRI bore 12.

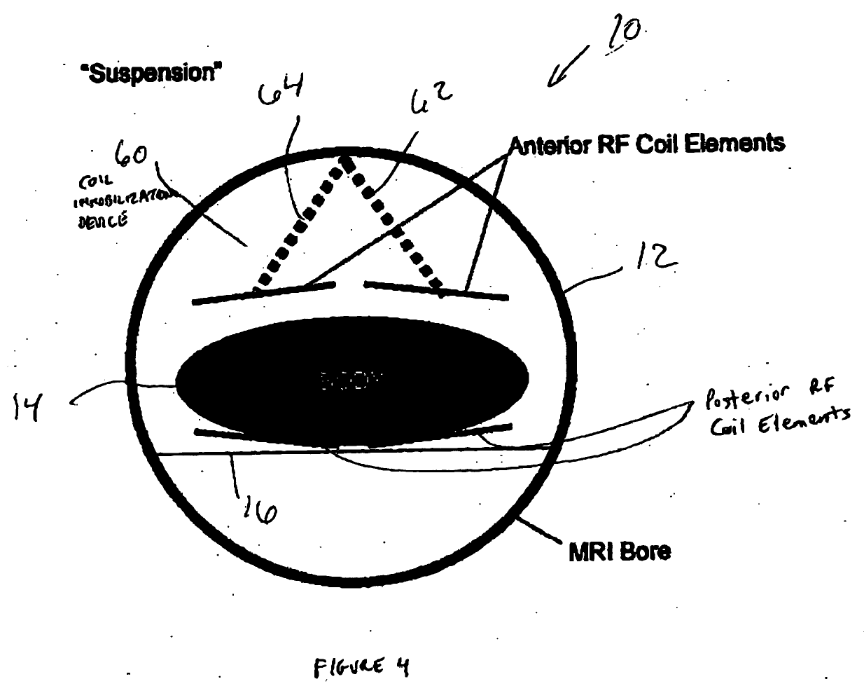

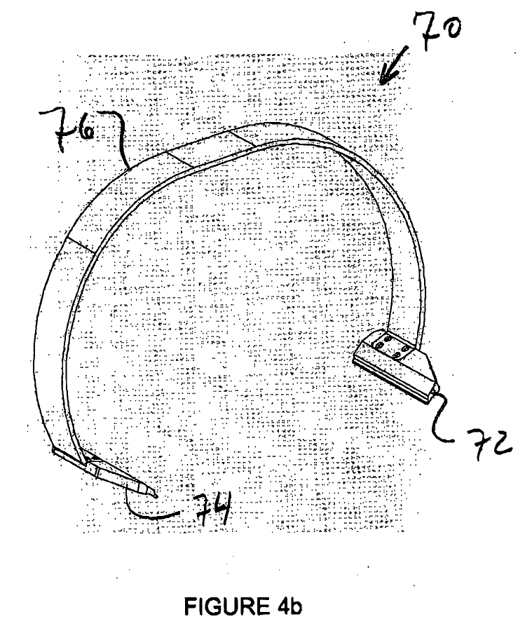

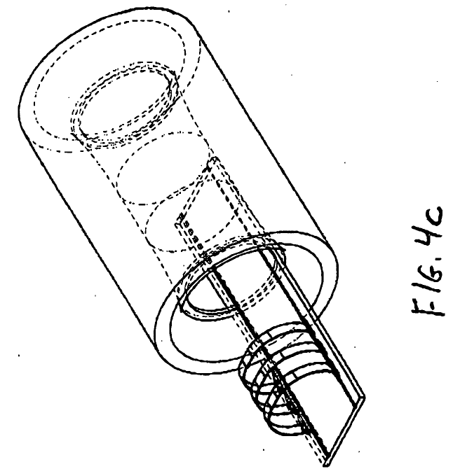

Referring now to FIG. 4, shown therein is a block diagram of another alternative embodiment of a coil immobilization device 60 in accordance with the present invention. The coil immobilization device 60 comprises two distancing members 62 and 64 that are suspended from the inner top portion of the MRI bore. The anterior RF imaging coil array is releasably mounted to the ends of the two distancing members 62 and 64 such that the RF imaging coil array is at rest. The length of the suspension members 62 and 64 can be varied to accommodate patients 14 with different body cavity thickness. The length of the distancing members 62 and 64 can be adjusted before the patient 14 is slid into the MRI bore 12. The distancing members 62 and 64 do not necessarily have to be suspended from the same point on the inner top portion of the MRI bore 12, nor do they have to be suspended from the topmost portion of the inner edge of the MRI bore 12. The distancing members may be telescopic or there can be a variety of different distancing members, having different lengths, to accommodate patients 14 with different body sizes.

Accordingly, the distancing members can be removably suspended from the top inner portion of the MRI bore. A variation on this embodiment includes one distancing member with a support member that is used to immobilize the anterior RF imaging coils.

Referring now to FIG. 4b, shown therein is a perspective view of another alternative embodiment of a coil immobilization device 70. Device 70 includes an arcuate or arched support member 76 so that it is parallel to the curvature of the chest or abdomen so the RF multi-coil array, when secured on top of immobilization device 70 has “uniform sensitivity” to the body. The perspective view shown in FIG. 4c shows an MRI system which has been retrofitted with the support members of FIG. 4b with the patient lying on the MRI table. Device 70 includes ends 72 and 74 which are adapted to engage the sides of MRI table 16 so that they can slide along to the desired position. Only one support 70 is shown but in general several will be present to fully support the anterior RF multi-coil array. In general, the coil immobilization device can be a rigid or a semi-rigid device that is capable of immobilizing the anterior RF imaging coils. The coil immobilization device can be made of any non-ferromagnetic or non MRI-signal influencing material. Examples of such materials include, but are not limited to, plastics, polymers, wood and the like.

The vertical dimensions of the coil immobilization device are such that the device can fit within the bore of the MRI scanner (typically the bore has a 60 cm diameter). The vertical dimensions of the coil immobilization device are adjustable so that the RF imaging coils are placed as close as possible to the patient's body so that the motion of the patient's body does not displace the RF imaging coils while at the same time minimizing distance related signal to noise reduction in the resultant MR images. Accordingly, embodiments in which the support member is arched to match the outer curvature of the patient's body are preferable. In fact, the support member can be made of a semi-rigid material so that the curvature of the support member can be changed depending of the body wall curvature of the patient that is currently being imaged. In this regards, embodiments in which the RF imaging coils are immobilized at an angle that matches the body wall curvature of the patient are also preferable.

There can also be variations in the embodiments shown herein in which the RF imaging coils are mounted to the bottom of the support member. The support member in the various embodiments can also be modified such that there are indentations in which the RF imaging coils are placed. The indentations have a shape that accommodates the shape of the RF imaging coils.

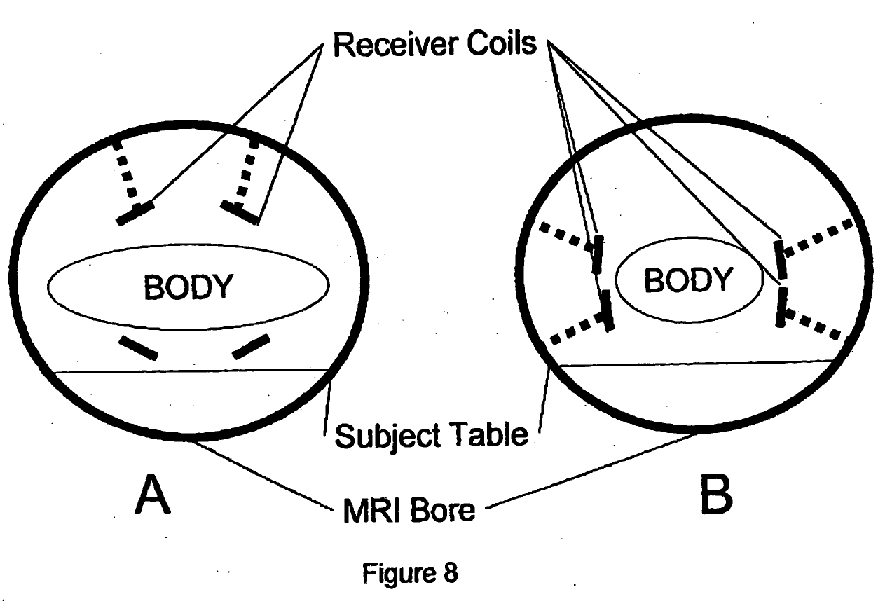

FIG. 8 is a diagram of an alternative embodiment of a coil immobilization device in accordance with the present invention in which Illustrations are shown for coils arranged in an “anterior/posterior” configuration, analogous coil arrays with coil elements to the “left” and “right” of the object are similarly shown.

Referring now to FIG. 5, shown therein are a series of panels of images illustrating a water phantom due to the effects of object displacement with and without a coil immobilization device. The water phantom included a container of water doped with copper sulphate solution to allow more rapid imaging (T1 shortening) which is common practice in phantom design. The upper two elements of a four-channel imaging coil array were displaced 1 cm between the calibration and image scans. The left topmost panel shows an image obtained with conventional MRI imaging methods. The remaining panels show images that were obtained with the ASSET image processing method. The top rightmost panel shows an MRI image obtained with a parallel factor of 2 without displacement of the test object. The parallel factor indicates the speed up factor in parallel imaging (this factor is usually 2 and cannot be more than the total number of imaging coils). The left bottommost panel shows an MRI image obtained with a parallel factor of 2 with displacement of the test object. There is a horizontal line artifact that is indicated by the arrow. The right bottommost panel shows an MRI image obtained with a parallel factor of 2, with a similar displacement of the test object and with the RF coils held in place by the coil immobilization device of the present invention. The artifact is no longer present.

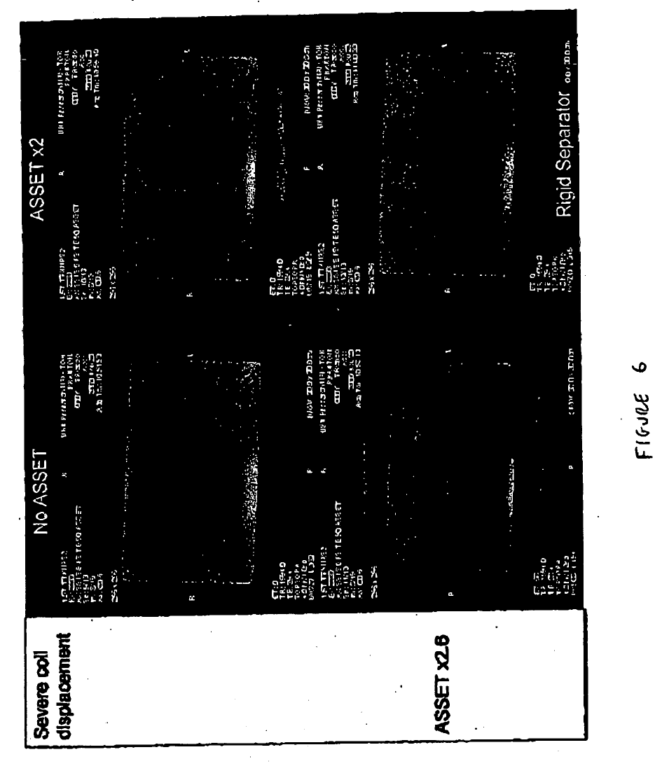

Referring now to FIG. 6, shown therein are a series of panels of images illustrating another water phantom due to the effects of object displacement with and without a coil immobilization device. The upper two elements of a four-channel imaging coil array were displaced several cm between the calibration and image scans. The left topmost panel shows an image obtained with conventional MRI imaging methods. The remaining panels show images that were obtained with the ASSET image processing method. The top rightmost panel shows an MRI image obtained with a parallel factor of 2 with displacement of the test object. The left bottommost panel shows an MRI image obtained with a parallel factor of 2.6 with displacement of the test object. The right bottommost panel shows an MRI image obtained with a parallel factor of 2.6, with a similar displacement of the test object and with the RF coils held in place by the coil immobilization device of the present invention. The artifact is no longer present.

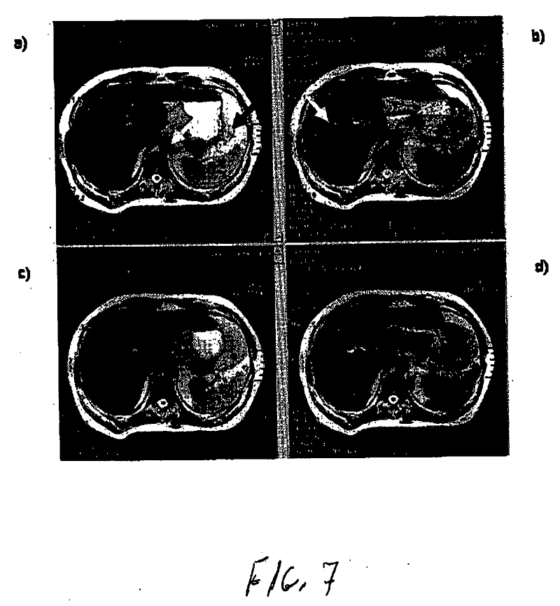

Referring now to FIG. 7 is a diagram illustrating MRI images obtained on a healthy volunteer with and without a coil immobilization device. A four-channel imaging coil array was used. The left topmost panel shows an image obtained with the ASSET image processing method using a parallel factor of 2 without the coil immobilization device. The ghost images, indicated by the two arrows, result in image quality degradation. The top rightmost panel shows an MRI image obtained with the ASSET image processing method using a parallel factor of 2.6 without the coil immobilization device. Once again, there are significant ghost images, indicated by the arrows, which degrade image quality. The left bottommost panel shows an MRI image obtained with the ASSET image processing method using a parallel factor of 2 with the coil immobilization device. The right bottommost panel shows an MRI obtained with the ASSET image processing method using a parallel factor of 2.6 with the coil immobilization device. In both cases, the ghost artifacts are no longer present and the image quality is enhanced.

Accelerated MRI techniques increase in speed with increasing “parallel factor”. This is commercially implemented as a factor of 2, but in development can been as high as 4.0 or more. In general, as the community moves to higher (than 1.5T) magnetic field strengths, with more intrinsic MR signal, one can speculate that the use of higher than 2.0 parallel factors (SENSE factor, ASSET factor) will increase. As shown in FIGS. 6 and 7, comparing ASSET factors of 2.0 and 2.6, obtained at 1.5T, the appearance of the ghost artifacts not only becomes more pronounced as the coil displacement increases, but also becomes more pronounced as the parallel factor is increased.

Advantageously, the coil immobilization device of the present invention can also reduce the ghost artifacts that occur when high parallel factors are used to generate the MRI images.

The device of the present invention can be used to immobilize imaging coil elements that may move due to a variety of reasons. Some examples include, but are not limited to: 1) endogenous movement (i.e. breathing which affects imaging of the abdomen, thorax, etc.), 2) necessary movement for kinematic studies (i.e. joint motion in the finger, wrist, shoulder, knee, ankle, etc.) and 3) external movement due to a consequence of external action (i.e. such as intervention or surgery of any body part).

Furthermore, the device of the present invention may be used for a variety of different magnetic resonance imaging methods. These methods include, but are not limited to, accelerated magnetic resonance imaging which comprises a family of parallel imaging techniques that use multiple imaging coils/receivers and sensitivity encoding, such as SENSE, SMASH, ASSET, iPAT, as a means of suppressing ghost artifacts in reconstructed images.

It should be understood that various modifications can be made, by those skilled in the art, to the preferred embodiments described and illustrated herein, without departing from the present invention.

As used herein, the terms “comprises”, “comprising”, “including” and “includes” are to be construed as being inclusive and open ended, and not exclusive. Specifically, when used in this specification including claims, the terms “comprises”, “comprising”, “including” and “includes” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

1. A method of parallel magnetic resonance imaging, comprising the steps of:
placing a patient on a magnetic resonance imaging (MRI) table and positioning anterior coil elements of a RF multi-coil imaging array around the patient at a sufficient distance so that the patient does not contact or otherwise move the coils;
performing a calibration scan of the multi-coil imaging array and storing calibration scan data;
performing a scan with the multi-coil imaging array and obtaining imaging data of a selected part of a patient's body and storing the imaging data; and
processing the calibration scan data and the imaging data to produce a final MRI image of the selected part of a patient's body.

2. The method according to claim 1 wherein the step of positioning anterior coil elements of a RF multi-coil imaging array around the patient at a sufficient distance so that the patient does not contact or otherwise move the coils includes affixing the anterior coil elements of the RF multi-coil imaging array to support members, and wherein the support members are made of a semi-rigid material so that a curvature of the support member can be changed depending of a body wall curvature of the patient that is currently being imaged.

3. The method according to claim 2 wherein the anterior coil elements of a RF multi-coil imaging array are immobilized at an angle that matches the body wall curvature of the patient are also preferable.

4. The method according to claim 1 wherein the selected part of a patient's body is the abdomen.

5. The method according to claim 1 wherein the selected part of a patient's body is the chest.

6. The method according to claim 1 wherein the selected part of a patient's body is the pelvis.

7. The method according to claim 1 wherein the selected part of a patient's body is a woman's fetus.

8. The method according to claim 1 wherein the sufficient distance is about 2 cm.

9. The method according to claim 1 wherein the parallel magnetic resonance imaging includes any one of kinematic, fetal, abdominal, and interventional magnetic resonance imaging.

10. The method according to claim 1 wherein the anterior coil elements of a RF multi-coil imaging array are positioned around the patient at the sufficient distance by being secured to rigid support members which are spaced above the magnetic resonance imaging (MRI) table.

11. The method according to claim 1 wherein the step of performing a calibration scan of the multi-coil imaging array and storing calibration scan data is performed before the step of performing a scan with the multi-coil imaging array and obtaining imaging data of a selected part of a patient's body and storing the imaging data.

12. The method according to claim 1 wherein the step of performing a calibration scan of the multi-coil imaging array and storing calibration scan data is performed after the step of performing a scan with the multi-coil imaging array and obtaining imaging data of a selected part of a patient's body and storing the imaging data.

13. The method according to claim 1 wherein the step of performing a calibration scan of the multi-coil imaging array and storing calibration scan data is performed during the step of performing a scan with the multi-coil imaging array and obtaining imaging data of a selected part of a patient's body and storing the imaging data.

15. A device for retrofitting to a magnetic resonance imaging apparatus for physically separating RF imaging coils from any source of movement by a patient thereby eliminating any potential coil-displacement related reconstruction effect or artifact in parallel magnetic resonance imaging, comprising:
at least one support member being attached to a magnetic resonance imaging apparatus, an RF multi-coil imaging array being attached to the at least one support member with the rigid support members being positioned with respect to a patient lying on a magnetic resonance imaging (MRI) table so that the RF multi-coil imaging array is positioned at a sufficient distance from the patient so that the patient does not contact or otherwise move the coils during movement, voluntary or involuntary.

16. The device according to claim 15 wherein the at least one support member is rigid, and are attachable to the magnetic resonance imaging (MRI) table.

17. The device according to claim 16 wherein the rigid support members have an arcurate shape.

18. The device according to claim 15 wherein the support members have an arcurate shape, and wherein the support members are made of a semi-rigid material so that a curvature of the support member can be changed depending of the body wall curvature of the patient that is currently being imaged.

19. The device according to claim 15 wherein the support members have ends which can be slidably engaged with sides of the magnetic resonance imaging (MRI) table.

20. The device according to claim 18 wherein the at least one semi-rigid support members have ends which can be slidably engaged with sides of the magnetic resonance imaging (MRI) table.

21. The device according to claim 15 wherein the support members are attachable to an interior surface of a bore of the magnetic resonance imaging apparatus.

22. The device according to claim 21 wherein the support members are suspended from a top inner surface of the bore.

23. The device according to claim 22 including adjustment means for adjusting a distance of the RF multi-coil imaging array above the patient.

24. The device according to claim 16 wherein the rigid support members are supported on brackets mounted on the sides of the interior surface of the bore.

25. The device according to claim 24 including adjustment means for adjusting a distance of the rigid support members above the above the patient for adjusting a distance of the RF multi-coil imaging array above the patient.

26. The device according to claim 15 wherein the at least one support members are made of a non-ferrous material.
